(19) United States
(12) Patent Application Publication
(10) Pub. No.: US 2024/0378210 A1
(43) Pub. Date: Nov. 14, 2024

(54) SYSTEMS AND METHODS FOR CUSTOMIZING SEARCH RANGES FOR LABELS ASSOCIATED WITH DOMAINS OF ATTRIBUTE VALUES

(71) Applicant: Shopify Inc., Ottawa (CA)

(72) Inventor: Amit Borkar, Haymarket, VA (US)

(21) Appl. No.: 18/314,488

(22) Filed: May 9, 2023

(51) Int. Cl. G06F 16/248; G06F 16/2455

(52) U.S. Cl. CPC G06F 16/248; G06F 16/2455

(57) ABSTRACT

A computer system receives a search query that includes a label corresponding to a domain of attribute values of items available for search on an online platform. In response to the search query, the computer system generates a first set of search results for output by a computing device, where the first set of search results are selected based in part on items in the first set of search results having attribute values that correspond to a first portion of the domain. The computer system maps the label to a second portion of the domain based on a user interaction with the first set of search results via the computing device. A second set of search results are generated for output by the computing device, where the second set of search results include items with attribute values that are within the second portion of the domain.

### TECHNICAL FIELD

The present disclosure relates to search engines, and in particular to customizing search ranges within domains of attribute values.

### BACKGROUND

Search engines are a common tool used to assist in the discovery of information or items of interest. In particular, many websites provide search engine functionality on their websites to enable their visitors to find desired items out of a set of items indexed by the website. Users of an online search engine sometimes submit queries that include labels intended to describe attributes of desired items. Some of these labels are subjective or have different meanings in different contexts.

### BRIEF DESCRIPTION OF THE DRAWINGS

Detailed descriptions of implementations of the present invention will be described and explained through the use of the accompanying drawings.

FIG. 1 is a block diagram illustrating an online search environment, according to some implementations.

FIG. 2 is a block diagram illustrating functional modules executed by the search system, according to some implementations.

FIGS. 3A-3C are user interfaces depicting example sets of search results that are generated in response to an example search query.

FIG. 4 is a flowchart illustrating a process for handling search queries containing labels that are associated with domains of attribute values, according to some implementations.

FIG. 5 illustrates an example e-commerce platform, according to some implementations.

FIG. 6 illustrates an example home page of an administrator.

FIG. 7 illustrates another implementation of an e-commerce platform.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Many websites provide search engine functionality, enabling visitors to the website to input queries for particular items of interest to the visitors. Search queries associated with websites often describe features of items in which a user may be interested using labels that are associated with domains of attribute values. For example, a query for a “light blue shirt” includes the label “light blue” to describe the color of a shirt for which a user is searching, where “light blue” represents a portion of a broader domain of possible colors of shirts that are indexed for search via the website. However, some of the labels that are submitted in search queries are subjective or may be intended to mean different things across different searches. Since a label may have different intended meanings in different search queries, it can be difficult for a search engine to correctly interpret these labels and to find search results that satisfy the user who input the query. Accordingly, a search system as described herein processes labels in search queries, mapping each label to a quantifiable portion of a domain of attribute values that enables the search system to produce search results that are satisfactory to its users.

According to implementations herein, a computer system generates a first set of search results for output by a computing device, in response to a search query, that includes a label corresponding to a domain of attribute values of items available for search on an online platform. The first set of search results are selected based in part on items in the first set of search results having attribute values that correspond to a first portion of the domain. Based on user interaction with the first set of search results, the computer system maps the label to a second portion of the domain. A second set of search results are then generated for output by the computing device, where the second set of search results includes items with attribute values that are within the second portion of the domain.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Search System

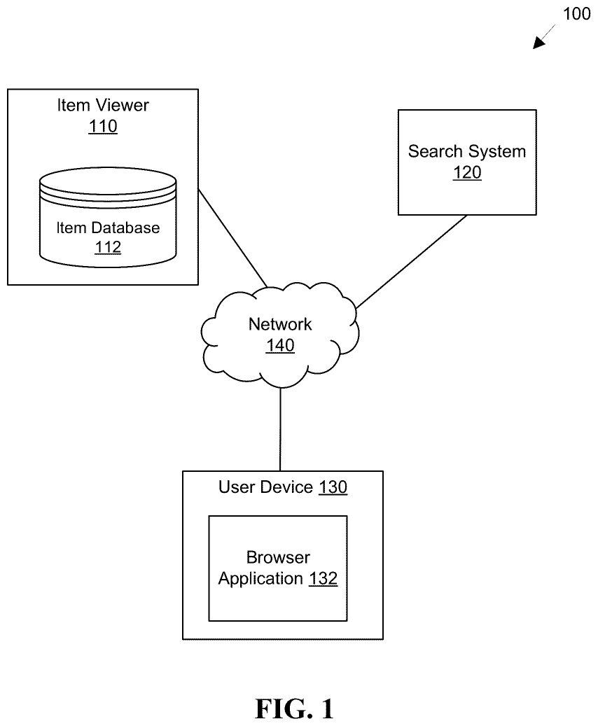

FIG. 1 is a block diagram illustrating an online search environment 100. As shown in FIG. 1, the environment 100 includes an item viewer 410110, a search system 120, and a user device 130, which communicate over a network 140 (such as the Internet). Other implementations of the environment 100 can include additional, fewer, or different entities.

The item viewer 410110 provides an interface for users to input search queries and to view and interact with search results generated based on the search queries. For example, the item viewer 110 includes a website. 110 As shown in FIG. 1, the item viewer 410110 also maintains an item database 112 with information about items that are indexed by, and thus searchable using, the item viewer 110. In particular, the item database 112 can store attributes of each respective item.

Some items in the item database 112 have attributes with values that fall within a domain of attribute values. For a given attribute, a domain of attribute values represents a set of possible quantizable or quantifiable values of the attribute among a set of corresponding items. Within the domain, the attribute values can be orderable (e.g., in a numerical order, an alphabetical order, etc.). Some attributes may have domains of values that are one-dimensional, while other attributes have values that are representable as multi-dimensional vectors, tuples, or surfaces. For example, color is an attribute that corresponds to a domain of possible attribute values. A color of an item can be represented as a tuple in a color space such as the red-green-blue (RGB), cyan-magenta-yellow-black (CMYK), or L*a*b* color spaces. Spatial dimensions of a physical product can similarly be represented by numerical, orderable domains of value: an area, for example of a product such as a rug, can be represented by a tuple or vector such as the tuple (<length>, <width>); a one-dimensional spatial measurement, such as the height of a rug's pile, can be represented as a float value. Light bulbs or other lighting instruments can have a color temperature attribute represented by a one-dimensional range of values (e.g., between 2700K and 6500K). Other attributes can be represented as a vector output by a trained machine learning model when a set of features of an item are input to the model. For example, items can be assigned attributes whose value is an embedding produced by a particular neural network when a certain set of item features are input to the neural network, where the set of embeddings produced by the neural network for a given set of items can be put in an order.

In one example, the item viewer 110 is an online store hosting one or more storefront websites that display the store's products or services to users, facilitate purchase of the products or services, and/or enable searching of the available products or services. In some implementations, the online store maintains user accounts for its customers, storing information such as past purchases by the user, rewards points collected by the user based on the past purchases, or browsing history of the user within the corresponding storefront. The item database 112 maintained by the item viewer 110 in this example includes information about the products or services offered for purchase through the store's website. Example item attributes stored in the item database 112 include unique identifiers of a product or service (e.g., a SKU), a category of the item, color, size, material, manufacturer, or descriptive labels added by a seller.

The user device 130 is a device used to access the item viewer 410110 and search for items indexed by the item viewer 110. The user device 130 can include, for example, a personal computer (PC), tablet computer, mobile telephone, game console, music player, wearable electronic device, network-connected (“smart”) device (e.g., a television or home assistant device), AR/VR systems (e.g., head-mounted display), or any other device capable of transmitting or receiving data over a network. In some implementations, the user device 130 executes a browser application 132 that is configured to access and render for display webpages from the item viewer 410110.

The search system 120 processes search queries for items indexed by the item viewer 410110. Some implementations of the search system 120 are integrated with and operated by the systems that operate the item viewer 410110. In other implementations, the search system 120 is a third-party system, or has functionality that is performed partially by the systems operating the item viewer 410110 and partially by a third-party system. Some implementations of the search system 120 by a third-party system provide search functionality to multiple online stores.

Some users search for items in the item viewer 410110 by inputting a text string to a search box on a website of the item viewer 410110. These search query strings can include labels that the user intends to describe an attribute of the item for which the user is searching, within a broader domain of possible values of the attribute. Such labels, which can include, for example, subjective descriptors of an item or user-specific descriptors, are sometimes terms about whose exact meanings people might disagree. In particular, when the label is associated with an attribute that has a domain of possible values, the portion of the domain to which the label corresponds is often subjective. For example, the range of shirt colors one user would consider to be “light blue” might only partially overlap or might be entirely different from the range of colors another user would be searching for when inputting a query for a “light blue shirt.”

The search system 120 processes queries that contain labels associated with domains of attributes values in order to map the labels to portions of the domains that are customized to respective users of the item viewer 410110.

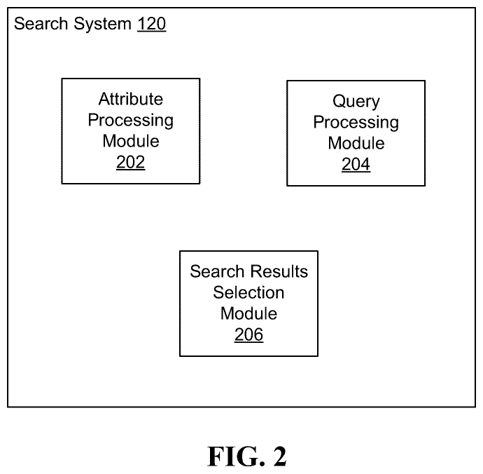

FIG. 2 is a block diagram illustrating functional modules executed by the search system 120. As shown in FIG. 2, an example implementation of the search system 120 includes an attribute processing module 202, a query processing module 204, and a search results selection module 206. The search system 120 can include additional, fewer, or different modules, and functionality described herein can be divided differently between the modules. As used herein, the term “module” refers broadly to software components, firmware components, and/or hardware components. Accordingly, the modules 202, 204, 206 could each be comprised of software, firmware, and/or hardware components implemented in, or accessible to, the search system 120.

The attribute processing module 202 ingests information about items available in the item viewer 410110 and determines attribute values for the items. For different types of attributes, the attribute processing module 202 can employ one or more data processing pipelines that identify a value of the attribute exhibited by a given item. For example, the attribute processing module 202 can ingest an image of an item and perform image processing techniques on the image to identify the item's color (as, for example, a particular RGB value). For another type of attribute that is represented as an embedding produced by a trained neural network, the attribute processing module 202 applies the trained neural network to applicable features of an item to generate the particular embedding that represents that item's attribute value. The attribute processing module 202 may store the determined attribute values in the item database 112 maintained by the online store or in a separate database used by other components of the search system 120. Items may have attributes stored in the item database 112 that are not generated by the attribute processing module 202, such as attributes added by an administrator associated with the item viewer 410110. The attribute processing module 202 may import these attributes to an attribute database used by the components of the search system 120, in some implementations.

The query processing module 204 processes search query strings received at the item viewer 110 to enable the search system 120 to select search results. The query processing module 204 can perform general parsing and analysis of a search query string that enable search results to be generated based on the string. When the query processing module 204 determines that a query includes a label associated with a domain of attribute values, the query processing module 204 maps the label to a portion of the domain.

In some implementations, the query processing module 204 identifies a domain of attributes values with which a label is associated by determining an ontology or term set to which the label belongs. For example, an ontology linked to the attribute “color” includes color names (e.g., “blue,” “teal,” or “aquamarine”) and descriptors that modify color names (e.g., “light,” “medium,” or “dark”). When the query processing module 204 parses a query string to identify a word or phrase within this ontology (e.g., “light blue” or “neon green” or “dark brick red”), the query processing module 204 determines the word or phrase is associated with a domain of color values. In another example, the query processing module 204 maintains a set of terms that are determined to relate to spatial dimensions of an object, including terms such as “large,” “XL,” “small,” “long,” “wide,” or “round.”

The query processing module 204 maps labels in search queries to portions of an associated domain of attribute values. For example, color-related labels can each be mapped to a range of color values. An initial mapping between a label and a portion of a domain is used to generate search results before user-specific preferences have been received. As users interact with search results generated for a given label, the query processing module 204 modifies the mapping of the label to customize the search results for a particular user.

The query processing module 204 can store initial mappings between labels and portions of a domain of attribute values. In some implementations, at least some of the initial mappings for a given domain are manually configured. For example, an administrator of the item viewer 410110 or search system 120 defines ranges of RGB values that correspond to each of several color labels. In other implementations, the query processing module 204 uses relative relationships between a set of labels associated with a given domain to map the labels to the attribute values present among a given set of products. The relationships between a set of labels can be ordinal relationships (e.g., the label “large” should be mapped to greater spatial dimensions than the label “small”) or expressed as a relationship between each label and a proportion of the domain (e.g., “large” is mapped to any spatial dimension that is greater than one standard deviation above the mean value of that dimension within a given set of items). The query processing module 204 then performs an automated process to divide a domain of attribute values among the set of labels, based on their relationships. For example, the query processing module 204 determines a range of spatial dimensions of items indexed by the item viewer 410110, then divides the determined range equally among the three labels “small,” “medium,” and “large.”

In still another implementation, the query processing module 204 uses historical average user behaviors to generate initial mappings between labels and portions of a domain, which are used to generate search results until the mappings are customized for a particular user. For example, the query processing module 204 stores the labels used in historical search queries and the corresponding attribute values of the items interacted with (e.g., viewed or purchased) by the users who submitted the search queries.

The initial mappings maintained by the query processing module 204 can be category-specific mappings, in some implementations. When used in relation to rugs, for example, the label “large” might typically represent very different spatial dimensions than when the term is applied to fasteners such as nails or screws. Accordingly, the query processing module 204 maps “large” to a first range of sizes for the item category of rugs, and to a second range of sizes for the item category of fasteners. Similarly, a user who submits a query for a “large shirt” might typically be looking for a shirt that is the specific clothing size large, rather than a range of sizes. Thus, for the item category of clothing, the term “large” is mapped to a specific size rather than to a range of values.

As users interact with search results, the query processing module 204 processes the user interactions to determine when to customize the mapping between a label and a portion of the corresponding domain. In general, the query processing module 204 uses a particular user's interactions with the search results generated in response to a label, in order to determine that the user is interested in objects whose attribute values are within a portion of the domain of values associated with the label that is different from the default portion. Subsequent search results can then be selected from the custom portion of the domain rather than the default portion.

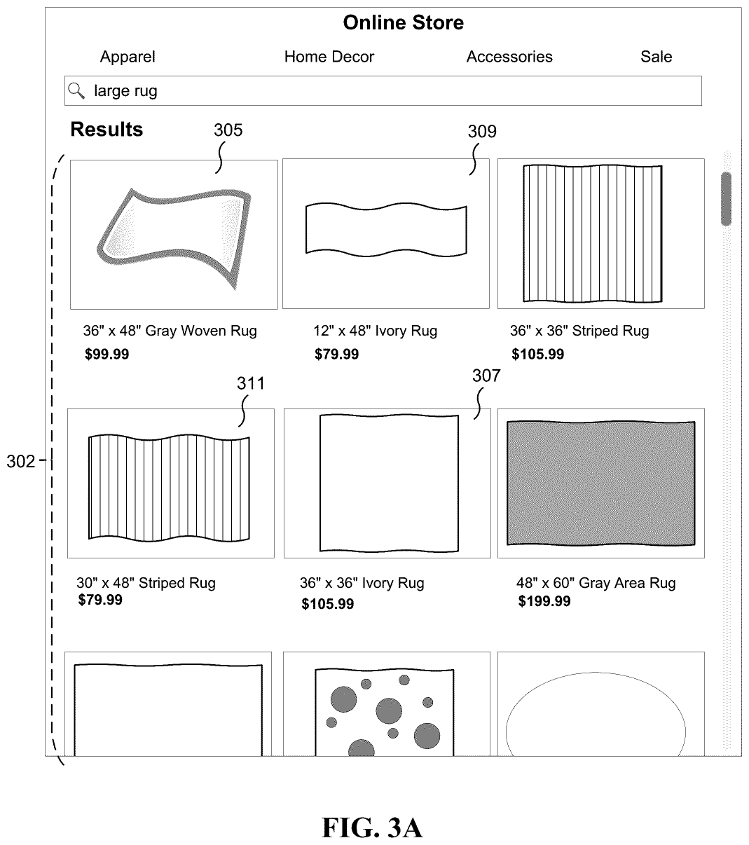

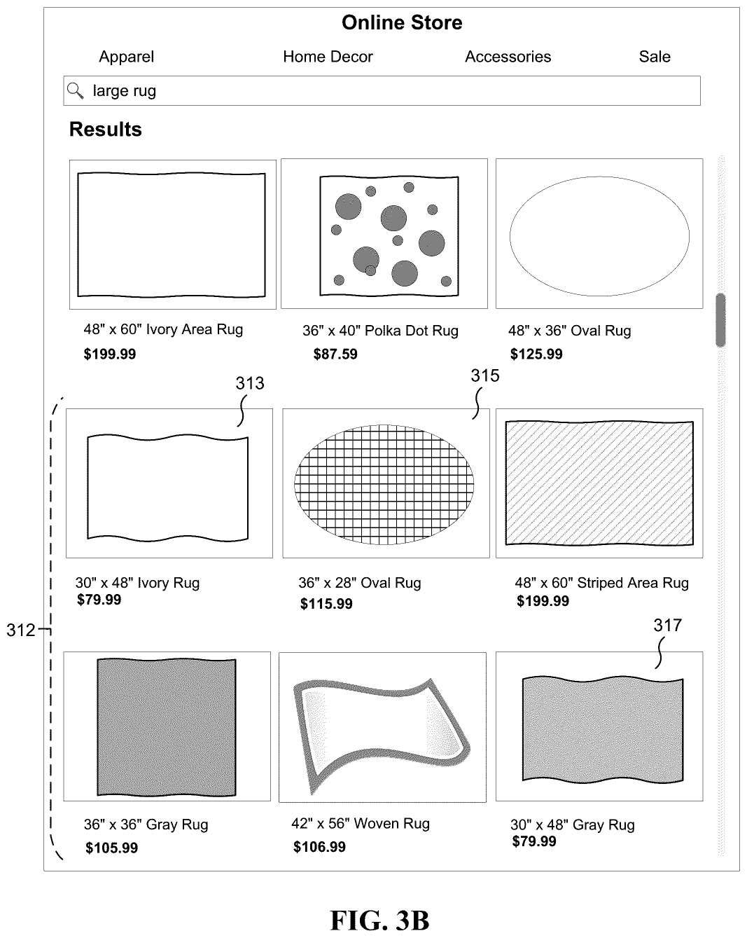

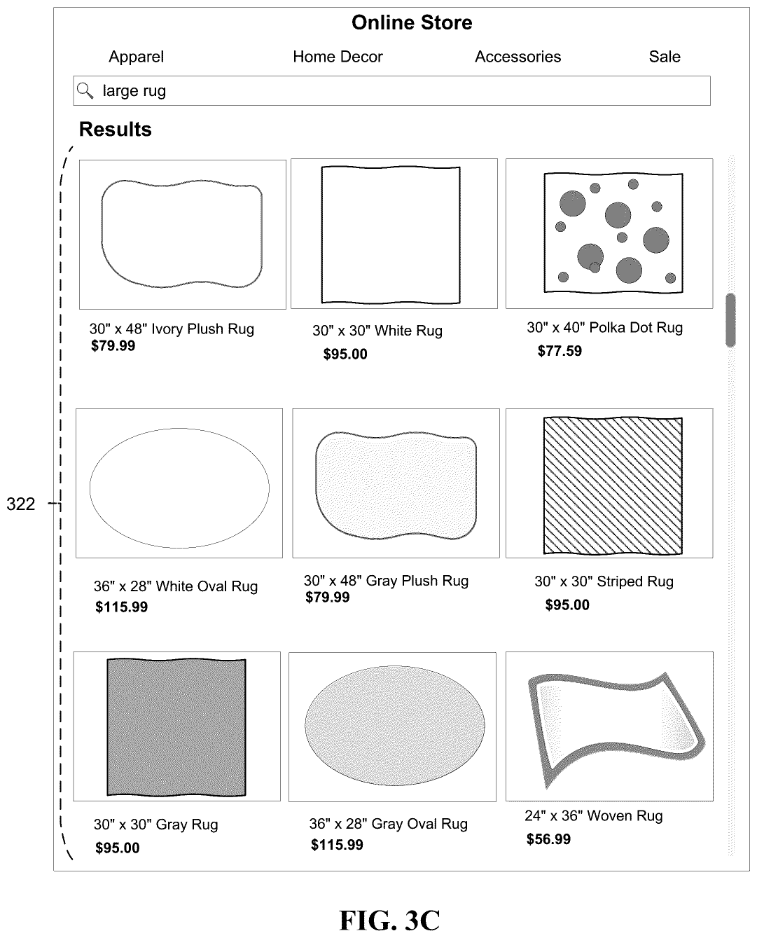

To illustrate user interactions with search results, FIGS. 3A-3C are user interfaces depicting example sets of search results that are generated in response to a query for a “large rug” input at an online storefront, as an example of the item viewer 110. In the example of FIG. 3A, the initial set of search results 302 contains nine results. As the user scrolls down the page, additional search results can be selected and displayed. Alternatively, the search result page can provide an option to navigate to a next page of search results, which if selected causes the search system 120 to generate additional search results. The initial set of search results 302 are selected based on an initial mapping between the label “large” and a first portion of a domain of spatial dimensions. For example, the initial mapping defines “large” as being any rug that is at least 36 inches wide by 36 inches long, but less than 60″×60″. In an initial set of search results 302 illustrated in FIG. 3A, at least some of the search results (such as items 305 and 307) have attributes that fall within this first portion of the domain. Some of the search results, however (such as items 309 and 311), can be items having attributes outside the first portion of the domain.

The items with attributes outside the initial mapped portion of the domain can be selected in several ways. In some implementations, an item is selected because it has an attribute value within a threshold distance of the first portion of the domain. The threshold can be defined based on a size of the first portion of the domain. For example, if the first portion of a one-dimensional domain includes attributes values 11-20 and the threshold is 10% of the size of this portion of the domain, search results with attribute values or 9 and/or 21 can be included among the initial set of search results. Alternatively, the threshold can be defined based on the attribute values that are included in the first portion of the domain. For example, if the first portion of a one-dimensional domain includes attribute values 10-20 and the threshold is 10% of the attribute values, search results with attribute values of 9 (10−(10*0.1)) or 22 (20+ (20*0.1)) can be included among the initial set of search results. In other implementations, the items that are outside the first portion of the domain can be selected by, for example, randomly sampling attribute values outside of the first portion of the domain, or selecting items with attribute values within a given threshold distance outside of the first portion. Alternatively, items outside the first portion of the domain can be selected independently of their attribute value corresponding to the label (e.g., based on other terms in the query, popularity of the item, ongoing promotions, etc.).

User interactions with search results include, in one example, engagement with one or more items in the search results. Such engagement can include, for example, a user selecting a search result to view more information about the corresponding item, hovering over the item with a cursor, or looking at a search result for a threshold amount of time (e.g., as detected by gaze tracking). The query processing module 204 can assess user engagement with search results as positive signals, indicating the user is interested in corresponding items and thus likely finds the items to have attributes that satisfy the search query.

The query processing module 204 monitors user engagement with the search query to determine if the user is engaging with items whose attributes are within the first portion of the domain or outside of the first portion. If the user engages with items whose attributes fall outside the first portion of the domain, the query processing module 204 determines if the user's engagement with these items satisfies a criterion for modifying the mapping of the label to the domain of attribute values. The criterion can include, for example, determining that the user engaged with at least a threshold number of items outside the first portion of the domain; determining that, of the number of items the user engaged with, at least a threshold percentage of the items had attributes outside the first portion of the domain; or determining that the user engaged with items within a first subset of the first portion of the domain, but not with items within a second subset of the first portion. If the user interaction with search results satisfies a criterion, the query processing module 204 modifies the mapping of the label to be mapped to a second portion of the domain of attribute values.

Depending on the items with which the user engages and the criterion that is satisfied by the engagements, the second portion of the domain may include attribute values that are not within the first portion of the domain, such that the second portion could either overlap or not overlap the first portion of the domain. The second portion of the domain may instead be a subset of the first portion of the domain. In an example, the query processing module 204 determines that the second portion of the domain includes a set of values just outside the first portion of the domain if the user interacts with a threshold number of items within this set of values. Referring to the search for a “large rug” depicted in FIG. 3A, for example, the query processing module 204 determines that the label “large” should be mapped to a portion of the domain of sizes that includes the 30″×48″ rug 311, based on the user's engagement with item 311 and other similarly sized rugs in the search results. In another example, the query processing module 204 determines that the second portion of the domain is a first subset of the first portion of the domain, based on the user's engagement with items in the first subset and lack of engagement with items in a second subset of the first portion of the domain.

Another possible type of user interaction with search results is a lack of engagement with any of the items, for example if the user scrolls past the entirety of an initial set of search results. When the user views but does not engage with at least a threshold number of search results generated for a given label, the query processing module 204 modifies the portion of the domain to which the label is mapped. For example, the query processing module 204 expands the size of the mapped portion of the domain (e.g., by both increasing an upper bound and decreasing a lower bound of each dimension in the domain), causing search results to be selected from the expanded portion of the domain rather than just the original portion. The query processing module 204 can alternatively shift the portion of the domain to which the label is mapped, for example by increasing both an upper bound and a lower bound of each dimension, decreasing both the upper bound and lower bound of each dimension, or increasing some dimensions while decreasing others. In still another example, the query processing module 204 causes subsequent sets of search results to include a greater number of items outside of the first portion of the domain in order to increase exploration of the domain of attribute values. For example, the first set of search results 302 depicted in FIG. 3A includes two items, 309 and 311, that are outside the first portion of the domain of spatial attribute values to which the label “large” was initially mapped. If the user scrolls past the nine results in the first set, the query processing module 204 causes the next set of search results to include, for example, three or four items that are outside the first portion of the domain. FIG. 3B illustrates an example in which a second set of search results 312 includes three results, 313, 315, and 317, outside the first portion of the domain.

As subsequent sets of search results are generated, including items that are outside the first portion of the domain of attribute values, the query processing module 204 tracks user engagement with any of the search results. If the user engages with the search results in a manner that satisfies a criterion for modifying the mapping of the label for the user, as described above, the query processing module 204 maps the label to a second portion of the domain of attribute values. Subsequent sets of search results can then be selected based on the second portion of the domain. For example, FIG. 3C depicts that a next set 322 of search results for the query “large rug” includes only search results that are smaller than the rugs in the search results in the initial set 302, based on a modified mapping of the term “large.”

In some implementations, the query processing module 204 stores any custom mappings between labels and attribute value domains, for example in a user account associated with the user or in a cookie stored in the user's browser, to enable use of the custom mapping in subsequent search sessions or on other item viewers 110 that use the same search system 120.

The search results selection module 206 selects and outputs search results that are responsive to each search query. For each query received at an item viewer 410110, the search results selection module 206 is configured to query the corresponding item database 112 to identify one or more items that match elements of the search query. The search results selection module 206 retrieves items with attribute values that satisfy instructions output by the query processing module 204, as the label mapping module monitors user interaction with search results and modifies the mapping between labels and portions of associated domains of attributes values.

Processing Search Queries Associated with Ranges of Attribute Values

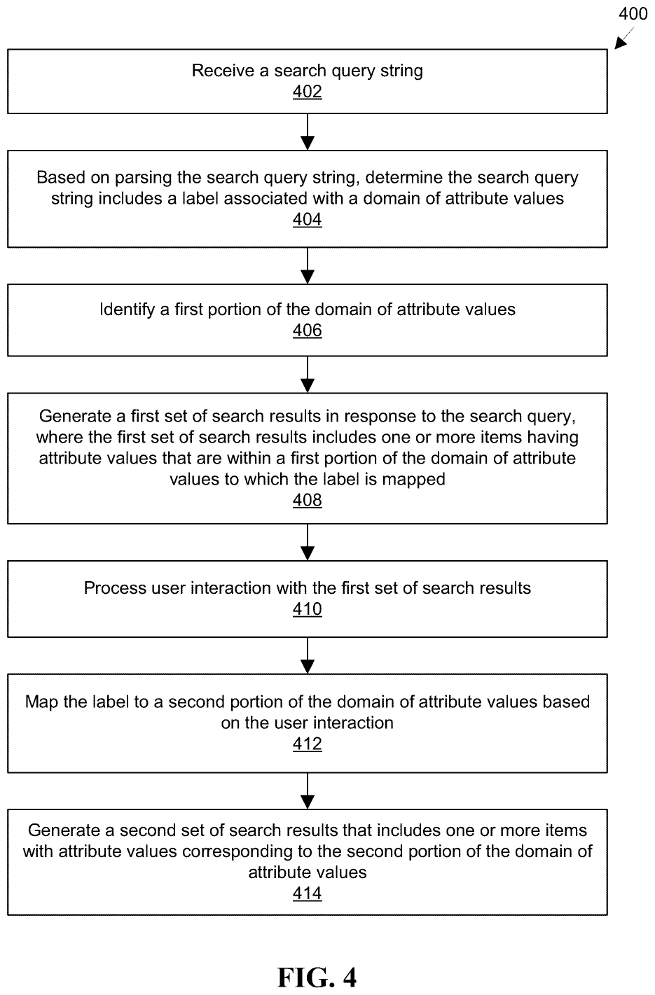

FIG. 4 is a flowchart illustrating a process 400 for handling search queries containing labels that are associated with domains of attribute values, according to some implementations. The process 400 can be performed by a computing system, such as the search system 120. Other implementations of the process 400 include additional, fewer, or different steps, or perform the steps in different orders.

As shown in FIG. 4, the computer system receives a search query string at 402. The search query string can be input by a user in a search box displayed on a website, for example. The computer system parses the query string and processes it for retrieving matching search results. For example, the computer system uses semantic-based or syntax-based techniques to process a search query, such as recognizing keywords in the query, analyzing parts of speech, predicting semantic relationships between terms in the query, disambiguating word senses, or performing other query processing techniques.

Based on processing of the search query string, the computer system determines, at 404, that a term in the search query is a label associated with a domain of attribute values. At 406, the computer system identifies a first portion of the domain of attribute values that is expected to correspond to the meaning of the label. A label can have a preconfigured mapping to a first portion of the domain, for example, or a mapping that is derived by the computer system based on factors such as a size of the domain or historical user behaviors. In some cases, the first portion of the domain is identified based on a category term that is also included in the search query.

The computer system generates a first set of search results at 408. The first set of search results includes one or more items with attribute values that are within the first portion of the domain of attribute values to which the label is mapped. In some implementations, the first set of search results also includes one or more items with attributes values that are outside the first portion of the domain. For example, if the first set of search results contains ten items, the computer system selects eight items that have attribute values within the first portion of the domain, and two items with attributes outside the first portion of the domain. When selecting items with attributes outside the first portion of the domain, some implementations of the computer system select an item that has an attribute value within a threshold distance of the first portion of the domain. For example, the threshold distance can be selected based on the size of the first portion of the domain or based on the magnitude of the attribute values that are included in the first portion of the domain.

At 410, the computer system processes a user interaction with the first set of search results. User interactions can include engagement with a search result in the first set, for example by selecting an item to view more information, hovering over the item with a cursor, or gazing at the item for at least a threshold amount of time. Alternatively, user interactions can include a display but not a selection of the search results in the first set. For example, a user may scroll past the first set of search results or navigate to a next page of search results.

Based on the user interaction, the computer system maps the label to a second portion of the domain of attribute values at 412. In some implementations, the label is mapped to the second portion of the domain if the user interaction satisfies a criterion, such as if the user interacts with a threshold number or percentage of search results with attributes that are in the second portion of the domain.

At 414, the computer system generates a second set of search results, which includes one or more items with attribute values that correspond to the second portion of the domain.

Steps of the process 400 can be repeated as a user interacts with search results, enabling the computer system to incrementally refine the customized mapping of the label for the user.

### An Example E-commerce Platform

Although integration with a commerce platform is not required, in some embodiments, the methods disclosed herein may be performed on or in association with a commerce platform such as an e-commerce platform. Therefore, an example of a commerce platform will be described.

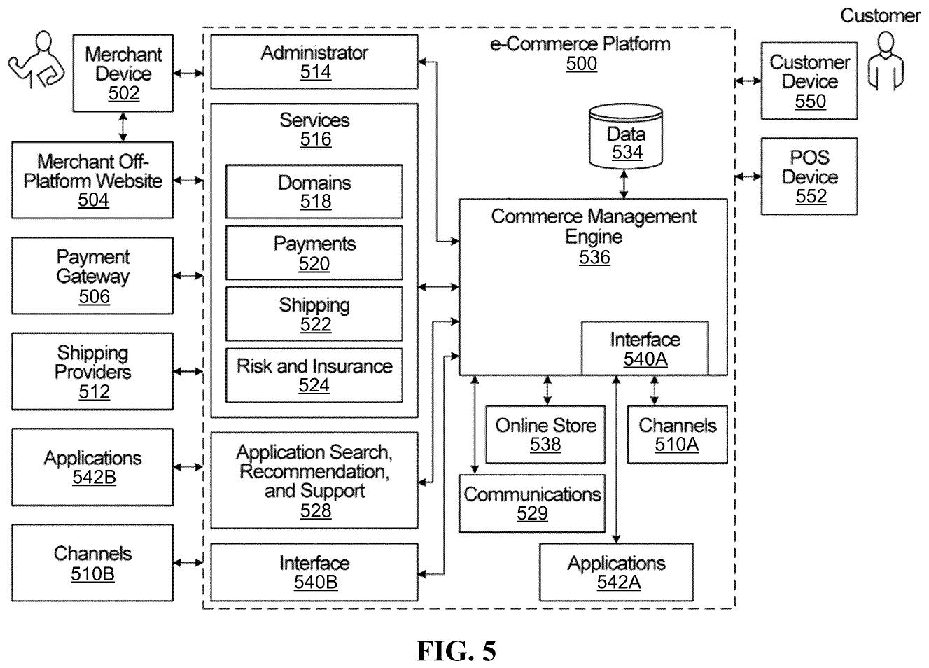

FIG. 5 illustrates an example e-commerce platform 500, according to one embodiment. The e-commerce platform 500 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 500 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 500 for potential use in marketing and selling products, and the like), a service provider user (e.g., a shipping provider 512, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 500 provides merchants with online services/facilities to manage their business. The facilities described herein are shown implemented as part of the platform 500 but could also be configured separately from the platform 500, in whole or in part, as stand-alone services. Furthermore, such facilities may, in some embodiments, may, additionally or alternatively, be provided by one or more providers/entities.

In the example of FIG. 5, the facilities are deployed through a machine, service or engine that executes computer software, modules, program codes, and/or instructions on one or more processors which, as noted above, may be part of or external to the platform 500. Merchants may utilize the e-commerce platform 500 for enabling or managing commerce with customers, such as by implementing an e-commerce experience with customers through an online store 538, applications 542A-B, channels 510A-B, and/or through point of sale (POS) devices 552 in physical locations (e.g., a physical storefront or other location such as through a kiosk, terminal, reader, printer, 3D printer, and the like). A merchant may utilize the e-commerce platform 500 as a sole commerce presence with customers, or in conjunction with other merchant commerce facilities, such as through a physical store (e.g., ‘brick-and-mortar’ retail stores), a merchant off-platform website 504 (e.g., a commerce Internet website or other internet or web property or asset supported by or on behalf of the merchant separately from the e-commerce platform 500), an application 542B, and the like. However, even these ‘other’ merchant commerce facilities may be incorporated into or communicate with the e-commerce platform 500, such as where POS devices 552 in a physical store of a merchant are linked into the e-commerce platform 500, where a merchant off-platform website 504 is tied into the e-commerce platform 500, such as, for example, through ‘buy buttons’ that link content from the merchant off platform website 504 to the online store 538, or the like.

The online store 538 may represent a multi-tenant facility comprising a plurality of virtual storefronts. In embodiments, merchants may configure and/or manage one or more storefronts in the online store 538, such as, for example, through a merchant device 502 (e.g., computer, laptop computer, mobile computing device, and the like), and offer products to customers through a number of different channels 510A-B (e.g., an online store 538; an application 542A-B; a physical storefront through a POS device 552; an electronic marketplace, such, for example, through an electronic buy button integrated into a website or social media channel such as on a social network, social media page, social media messaging system; and/or the like). A merchant may sell across channels 510A-B and then manage their sales through the e-commerce platform 500, where channels 510A may be provided as a facility or service internal or external to the e-commerce platform 500. A merchant may, additionally or alternatively, sell in their physical retail store, at pop ups, through wholesale, over the phone, and the like, and then manage their sales through the e-commerce platform 500. A merchant may employ all or any combination of these operational modalities. Notably, it may be that by employing a variety of and/or a particular combination of modalities, a merchant may improve the probability and/or volume of sales. Throughout this disclosure the terms online store 538 and storefront may be used synonymously to refer to a merchant's online e-commerce service offering through the e-commerce platform 500, where an online store 538 may refer either to a collection of storefronts supported by the e-commerce platform 500 (e.g., for one or a plurality of merchants) or to an individual merchant's storefront (e.g., a merchant's online store).

In some embodiments, a customer may interact with the platform 500 through a customer device 550 (e.g., computer, laptop computer, mobile computing device, or the like), a POS device 552 (e.g., retail device, kiosk, automated (self-service) checkout system, or the like), and/or any other commerce interface device known in the art. The e-commerce platform 500 may enable merchants to reach customers through the online store 538, through applications 542A-B, through POS devices 552 in physical locations (e.g., a merchant's storefront or elsewhere), to communicate with customers via electronic communication facility 529, and/or the like so as to provide a system for reaching customers and facilitating merchant services for the real or virtual pathways available for reaching and interacting with customers.

In some embodiments, and as described further herein, the e-commerce platform 500 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 500 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 500, merchant devices 502, payment gateways 506, applications 542A-B, channels 510A-B, shipping providers 512, customer devices 550, point of sale devices 552, etc., In some implementations, the processing facility may be or may include one or more such computing devices acting in concert. For example, it may be that a plurality of co-operating computing devices serves as/to provide the processing facility. The e-commerce platform 500 may be implemented as or using one or more of a cloud computing service, software as a service (Saas), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 538) is provided as a service, and is centrally hosted (e.g., and then accessed by users via a web browser or other application, and/or through customer devices 550, POS devices 552, and/or the like). In some embodiments, elements of the e-commerce platform 500 may be implemented to operate and/or integrate with various other platforms and operating systems.

In some embodiments, the facilities of the e-commerce platform 500 (e.g., the online store 538) may serve content to a customer device 550 (using data 534) such as, for example, through a network connected to the e-commerce platform 500. For example, the online store 538 may serve or send content in response to requests for data 534 from the customer device 550, where a browser (or other application) connects to the online store 538 through a network using a network communication protocol (e.g., an internet protocol). The content may be written in machine readable language and may include Hypertext Markup Language (HTML), template language, JavaScript, and the like, and/or any combination thereof.

In some embodiments, online store 538 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 538 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 538, such as through blogs, articles, landing pages, and the like, as well as configure navigation menus. Merchants may upload images (e.g., for products), video, content, data, and the like to the e-commerce platform 500, such as for storage by the system (e.g., as data 534). In some embodiments, the e-commerce platform 500 may provide functions for manipulating such images and content such as, for example, functions for resizing images, associating an image with a product, adding and associating text with an image, adding an image for a new product variant, protecting images, and the like.

As described herein, the e-commerce platform 500 may provide merchants with sales and marketing services for products through a number of different channels 510A-B, including, for example, the online store 538, applications 542A-B, as well as through physical POS devices 552 as described herein. The e-commerce platform 500 may, additionally or alternatively, include business support services 516, an administrator 514, a warehouse management system, and the like associated with running an on-line business, such as, for example, one or more of providing a domain registration service 518 associated with their online store, payment services 520 for facilitating transactions with a customer, shipping services 522 for providing customer shipping options for purchased products, fulfillment services for managing inventory, risk and insurance services 524 associated with product protection and liability, merchant billing, and the like. Services 516 may be provided via the e-commerce platform 500 or in association with external facilities, such as through a payment gateway 506 for payment processing, shipping providers 512 for expediting the shipment of products, and the like.

In some embodiments, the e-commerce platform 500 may be configured with shipping services 522 (e.g., through an e-commerce platform shipping facility or through a third-party shipping carrier), to provide various shipping-related information to merchants and/or their customers such as, for example, shipping label or rate information, real-time delivery updates, tracking, and/or the like.

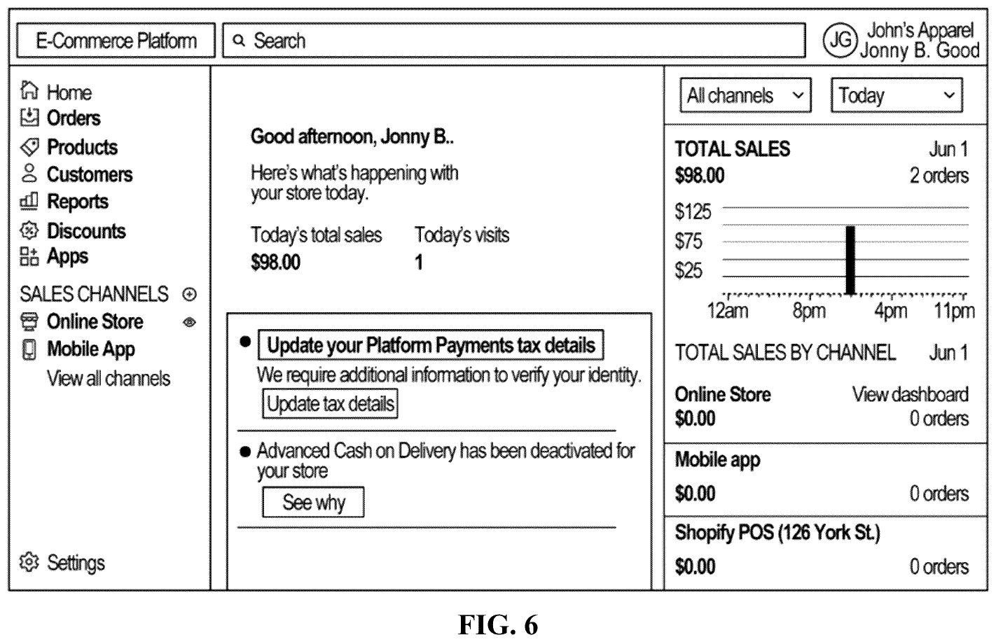

FIG. 6 depicts a non-limiting embodiment for a home page of an administrator 514. The administrator 514 may be referred to as an administrative console and/or an administrator console. The administrator 514 may show information about daily tasks, a store's recent activity, and the next steps a merchant can take to build their business. In some embodiments, a merchant may log in to the administrator 514 via a merchant device 502 (e.g., a desktop computer or mobile device), and manage aspects of their online store 538, such as, for example, viewing the online store's 538 recent visit or order activity, updating the online store's 538 catalog, managing orders, and/or the like. In some embodiments, the merchant may be able to access the different sections of the administrator 514 by using a sidebar, such as the one shown on FIG. 6. Sections of the administrator 514 may include various interfaces for accessing and managing core aspects of a merchant's business, including orders, products, customers, available reports and discounts. The administrator 514 may, additionally or alternatively, include interfaces for managing sales channels for a store including the online store 538, mobile application(s) made available to customers for accessing the store (Mobile App), POS devices, and/or a buy button. The administrator 514 may, additionally or alternatively, include interfaces for managing applications (apps) installed on the merchant's account; and settings applied to a merchant's online store 538 and account. A merchant may use a search bar to find products, pages, or other information in their store.

More detailed information about commerce and visitors to a merchant's online store 538 may be viewed through reports or metrics. Reports may include, for example, acquisition reports, behavior reports, customer reports, finance reports, marketing reports, sales reports, product reports, and custom reports. The merchant may be able to view sales data for different channels 510A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 538, such as based on account status, growth, recent customer activity, order updates, and the like. Notifications may be provided to assist a merchant with navigating through workflows configured for the online store 538, such as, for example, a payment workflow, an order fulfillment workflow, an order archiving workflow, a return workflow, and the like.

The e-commerce platform 500 may provide for a communications facility 529 and associated merchant interface for providing electronic communications and marketing, such as utilizing an electronic messaging facility for collecting and analyzing communication interactions between merchants, customers, merchant devices 502, customer devices 550, POS devices 552, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 529 is configured to provide automated responses to customer requests and/or provide recommendations to the merchant on how to respond such as, for example, to improve the probability of a sale.

The e-commerce platform 500 may provide a financial facility 520 for secure financial transactions with customers, such as through a secure card server environment. The e-commerce platform 500 may store credit card information, such as in payment card industry data (PCI) environments (e.g., a card server), to reconcile financials, bill merchants, perform automated clearing house (ACH) transfers between the e-commerce platform 500 and a merchant's bank account, and the like. The financial facility 520 may also provide merchants and buyers with financial support, such as through the lending of capital (e.g., lending funds, cash advances, and the like) and provision of insurance. In some embodiments, online store 538 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 500. In some embodiments, the e-commerce platform 500 may store this data in a data facility 534. Referring again to FIG. 5, in some embodiments the e-commerce platform 500 may include a commerce management engine 536 such as may be configured to perform various workflows for task automation or content management related to products, inventory, customers, orders, suppliers, reports, financials, risk and fraud, and the like. In some embodiments, additional functionality may, additionally or alternatively, be provided through applications 542A-B to enable greater flexibility and customization required for accommodating an ever-growing variety of online stores, POS devices, products, and/or services. Applications 542A may be components of the e-commerce platform 500 whereas applications 542B may be provided or hosted as a third-party service external to e-commerce platform 500. The commerce management engine 536 may accommodate store-specific workflows and in some embodiments, may incorporate the administrator 514 and/or the online store 538.

Implementing functions as applications 542A-B may enable the commerce management engine 536 to remain responsive and reduce or avoid service degradation or more serious infrastructure failures, and the like.

Although isolating online store data can be important to maintaining data privacy between online stores 538 and merchants, there may be reasons for collecting and using cross-store data, such as for example, with an order risk assessment system or a platform payment facility, both of which require information from multiple online stores 538 to perform well. In some embodiments, it may be preferable to move these components out of the commerce management engine 536 and into their own infrastructure within the e-commerce platform 500.

Platform payment facility 520 is an example of a component that utilizes data from the commerce management engine 536 but is implemented as a separate component or service. The platform payment facility 520 may allow customers interacting with online stores 538 to have their payment information stored safely by the commerce management engine 536 such that they only have to enter it once. When a customer visits a different online store 538, even if they have never been there before, the platform payment facility 520 may recall their information to enable a more rapid and/or potentially less-error prone (e.g., through avoidance of possible mis-keying of their information if they needed to instead re-enter it) checkout. This may provide a cross-platform network effect, where the e-commerce platform 500 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 538.

For functions that are not included within the commerce management engine 536, applications 542A-B provide a way to add features to the e-commerce platform 500 or individual online stores 538. For example, applications 542A-B may be able to access and modify data on a merchant's online store 538, perform tasks through the administrator 514, implement new flows for a merchant through a user interface (e.g., that is surfaced through extensions/API), and the like. Merchants may be enabled to discover and install applications 542A-B through application search, recommendations, and support 528. In some embodiments, the commerce management engine 536, applications 542A-B, and the administrator 514 may be developed to work together. For instance, application extension points may be built inside the commerce management engine 536, accessed by applications 542A and 542B through the interfaces 540B and 540A to deliver additional functionality, and surfaced to the merchant in the user interface of the administrator 514.

In some embodiments, applications 542A-B may deliver functionality to a merchant through the interface 540A-B, such as where an application 542A-B is able to surface transaction data to a merchant (e.g., App: “Engine, surface my app data in the Mobile App or administrator 514”), and/or where the commerce management engine 536 is able to ask the application to perform work on demand (Engine: “App, give me a local tax calculation for this checkout”).

Applications 542A-B may be connected to the commerce management engine 536 through an interface 540A-B (e.g., through REST (REpresentational State Transfer) and/or GraphQL APIs) to expose the functionality and/or data available through and within the commerce management engine 536 to the functionality of applications. For instance, the e-commerce platform 500 may provide API interfaces 540A-B to applications 542A-B which may connect to products and services external to the platform 500. The flexibility offered through use of applications and APIs (e.g., as offered for application development) enable the e-commerce platform 500 to better accommodate new and unique needs of merchants or to address specific use cases without requiring constant change to the commerce management engine 536. For instance, shipping services 522 may be integrated with the commerce management engine 536 through a shipping or carrier service API, thus enabling the e-commerce platform 500 to provide shipping service functionality without directly impacting code running in the commerce management engine 536.

Depending on the implementation, applications 542A-B may utilize APIs to pull data on demand (e.g., customer creation events, product change events, or order cancelation events, etc.) or have the data pushed when updates occur. A subscription model may be used to provide applications 542A-B with events as they occur or to provide updates with respect to a changed state of the commerce management engine 536. In some embodiments, when a change related to an update event subscription occurs, the commerce management engine 536 may post a request, such as to a predefined callback URL. The body of this request may contain a new state of the object and a description of the action or event. Update event subscriptions may be created manually, in the administrator facility 514, or automatically (e.g., via the API 540A-B). In some embodiments, update events may be queued and processed asynchronously from a state change that triggered them, which may produce an update event notification that is not distributed in real-time or near-real time.

In some embodiments, the e-commerce platform 500 may provide one or more of application search, recommendation and support 528. Application search, recommendation and support 528 may include developer products and tools to aid in the development of applications, an application dashboard (e.g., to provide developers with a development interface, to administrators for management of applications, to merchants for customization of applications, and the like), facilities for installing and providing permissions with respect to providing access to an application 542A-B (e.g., for public access, such as where criteria must be met before being installed, or for private use by a merchant), application searching to make it easy for a merchant to search for applications 542A-B that satisfy a need for their online store 538, application recommendations to provide merchants with suggestions on how they can improve the user experience through their online store 538, and the like. In some embodiments, applications 542A-B may be assigned an application identifier (ID), such as for linking to an application (e.g., through an API), searching for an application, making application recommendations, and the like.

Applications 542A-B may be grouped roughly into three categories: customer-facing applications, merchant-facing applications, integration applications, and the like. Customer-facing applications 542A-B may include an online store 538 or channels 510A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 542A-B may include applications that allow the merchant to administer their online store 538 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 512 and payment gateways 506.

As such, the e-commerce platform 500 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 510A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 510A-B such as, for example, the merchant's online store 538, a physical storefront through a POS device 552; an electronic marketplace, through an electronic buy button integrated into a website or a social media channel). In some cases, channels 510A-B may be modeled as applications 542A-B A merchandising component in the commerce management engine 536 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 536 may be configured to receive customer information to complete the order such as the customer's contact information, billing information and/or shipping details. If the customer inputs their contact information but does not proceed to payment, the e-commerce platform 500 may (e.g., via an abandoned checkout component) to transmit a message to the customer device 550 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 536 may be configured to communicate with various payment gateways and services 506 (e.g., online payment systems, mobile payment systems, digital wallets, credit card gateways) via a payment processing component. The actual interactions with the payment gateways 506 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 536 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 536 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 536. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 500 may make the merchant aware of compliance issues with respect to legal obligations (e.g., with respect to taxes). In some embodiments, the e-commerce platform 500 may enable merchants to keep track of changes to the contract of sales over time, such as implemented through a sales model component (e.g., an append-only date-based ledger that records sale-related events that happened to an item).

### Implementation in an E-Commerce Platform

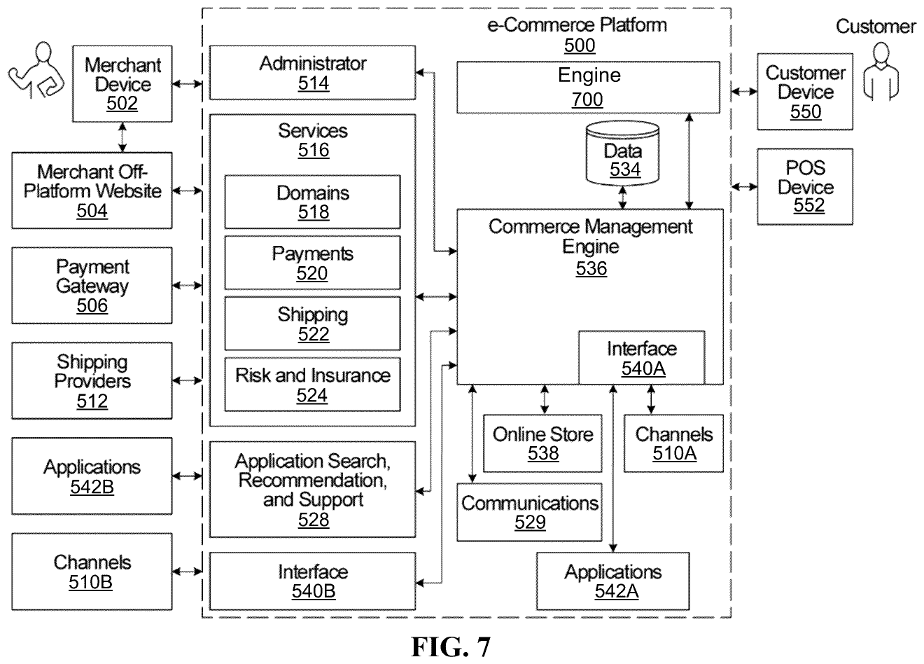

The functionality described herein may be used in commerce to provide improved customer or buyer experiences. The e-commerce platform 500 could implement the functionality for any of a variety of different applications, examples of which are described elsewhere herein. FIG. 7 illustrates the e-commerce platform 500 of FIG. 5 but including an engine 700. The engine 700 is an example of a computer-implemented system that implements the functionality described herein for use by the e-commerce platform 500, the customer device 550 and/or the merchant device 502.

Although the engine 700 is illustrated as a distinct component of the e-commerce platform 500 in FIG. 7, this is only an example. An engine could also or instead be provided by another component residing within or external to the e-commerce platform 500. In some embodiments, either or both of the applications 542A-B provide an engine that implements the functionality described herein to make it available to customers and/or to merchants. Furthermore, in some embodiments, the commerce management engine 536 provides that engine. However, the location of the engine 700 is implementation specific. In some implementations, the engine 700 is provided at least in part by an e-commerce platform, either as a core function of the e-commerce platform or as an application or service supported by or communicating with the e-commerce platform. Alternatively, the engine 700 may be implemented as a stand-alone service to clients such as a customer device 550 or a merchant device 502. In addition, at least a portion of such an engine could be implemented in the merchant device 502 and/or in the customer device 550. For example, the customer device 550 could store and run an engine locally as a software application.

The engine 700 could implement at least some of the functionality described herein. Although the embodiments described below may be implemented in association with an e-commerce platform, such as (but not limited to) the e-commerce platform 500, the embodiments described below are not limited to e-commerce platforms.

### Computer System

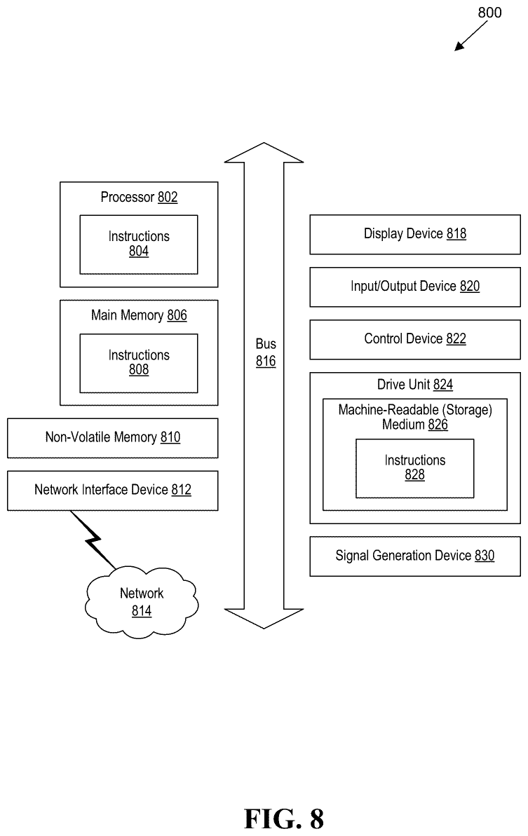

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, video display device 818, an input/output device 820, a control device 822 (e.g., keyboard and pointing device), a drive unit 824 that includes a storage medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementation, the computer system 800 can be an embedded computer system, a system-on-chip (SOC), a single-board computer system (SBC) or a distributed system such as a mesh of computer systems or include one or more cloud components in one or more networks. Where appropriate, one or more computer systems 800 can perform operations in real-time, near real-time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method comprising:
generating, in response to a search query, a first set of search results for output by a computing device, the search query including a label corresponding to a domain of attribute values of items available for search on an online platform, wherein the domain of attribute values represents a set of measurable values of an attribute, and wherein the first set of search results are selected based in part on items in the first set of search results having attribute values that correspond to a first portion of the domain;
mapping the label to a second portion of the domain based on a user interaction with the first set of search results via the computing device; and
generating a second set of search results for output by the computing device, the second set of search results including items with attribute values that are within the second portion of the domain.

2. The computer-implemented method of claim 1, wherein the first set of search results further include one or more items having attribute values that are outside of the first portion of the domain.

3. The computer-implemented method of claim 2, wherein the one or more items having attribute values that are outside of the first portion of the domain include an item with an attribute value within a threshold distance of the first portion of the domain.

4. The computer-implemented method of claim 3, wherein the threshold distance is selected based on a size of the first portion of the domain.

5. The computer-implemented method of claim 3, wherein the threshold distance is selected based on the attribute values that are included in the first portion of the domain.

6. The computer-implemented method of claim 1, wherein the user interaction with the first set of search results comprises a user selection, on the computing device, of a threshold number of search results in the first set, and wherein mapping the label to the second portion of the domain comprises identifying, as the second portion, a portion of the domain that includes attribute values of items corresponding to the selected search results.

7. The computer-implemented method of claim 6, wherein the second portion of the domain includes attribute values that are not within the first portion of the domain.

8. The computer-implemented method of claim 6, wherein the second portion of the domain is a subset of the first portion of the domain.

9. The computer-implemented method of claim 1, wherein the user interaction with the first set of search results comprises a display but not a selection of search results in the first set on the computing device, and wherein the method further comprises, in response to detecting a specified number of search results in the first set have been displayed but not selected:
expanding the first portion of the domain;
generating a third set of search results including items with attribute values that are within the expanded first portion of the domain; and
outputting the third set of search results to the computing device.

10. The computer-implemented method of claim 9, wherein mapping the label to the second portion of the domain comprises mapping the label to the second portion of the domain based on a user interaction with the results in the third set via the computing device.

11. The computer-implemented method of claim 1, wherein the interaction with the first set of search results comprises a display of but not a selection of search results in the first set on the computing device, and wherein the method further comprises, in response to detecting a specified number of search results in the first set have been displayed but not selected:
selecting a third set of search results, wherein the third set of search results includes a specified number of items with attribute values that are outside the first portion of the domain; and
outputting the third set of search results to the computing device.

12. The computer-implemented method of claim 1, wherein the search query further includes a category term associated with the label, and wherein the method further comprises:
identifying the first portion of the domain based on the category term.

13. The computer-implemented method of claim 1, wherein an attribute value of an item relates to a color of the item.

14. The computer-implemented method of claim 13, further comprising:
for each of a plurality of the items available for search on the online platform, processing an image of the item to generate a tuple to represent the color of the item.

15. The computer-implemented method of claim 1, wherein an attribute value of an item relates to a size of at least one spatial dimension of the item.

16. The computer-implemented method of claim 1, wherein an attribute value of an item relates to a vector output by a machine learning model applied to a plurality of features of the item.

17. A non-transitory computer readable storage medium storing executable instructions, execution of which by a processor causing the processor to:
generate, in response to a search query, a first set of search results for output by a computing device, the search query including a label corresponding to a domain of attribute values of items available for search on an online platform, wherein the domain of attribute values represents a set of measurable values of an attribute, and wherein the first set of search results are selected based in part on items in the first set of search results having attribute values that correspond to a first portion of the domain;
map the label to a second portion of the domain based on a user interaction with the first set of search results via the computing device; and
generate a second set of search results for output by the computing device, the second set of search results including items with attribute values that are within the second portion of the domain.

18. The non-transitory computer readable storage medium of claim 17, wherein the first set of search results further include one or more items having attribute values that are outside of the first portion of the domain.

19. The non-transitory computer readable storage medium of claim 17, wherein the user interaction with the first set of search results comprises a user selection, on the computing device, of a threshold number of search results in the first set, and wherein mapping the label to the second portion of the domain comprises identifying, as the second portion, a portion of the domain that includes attribute values of items corresponding to the selected search results.

20. A system comprising:
at least one hardware processor; and
at least one non-transitory memory storing instructions, which, when executed by the at least one hardware processor, cause the system to:
generate, in response to a search query, a first set of search results for output by a computing device, the search query including a label corresponding to a domain of attribute values of items available for search on an online platform, wherein the domain of attribute values represents a set of measurable values of an attribute, and wherein the first set of search results are selected based in part on items in the first set of search results having attribute values that correspond to a first portion of the domain;
map the label to a second portion of the domain based on a user interaction with the first set of search results via the computing device; and
generate a second set of search results for output by the computing device, the second set of search results including items with attribute values that are within the second portion of the domain.
